(19) United States
(12) Patent Application Publication
(10) Pub. No.: US 2026/0112060 A1
(43) Pub. Date: Apr. 23, 2026

(54) ALIGNMENT METHOD AND ELECTRONIC DEVICE INCLUDING SAME

(71) Applicant: Vieworks Co., Ltd., Anyang-si (KR)

(72) Inventors: Joong Geun KIM, Hwaseong-si (KR); Seung Hyun KIM, Seongnam-si (KR); Tae Jun LIM, Incheon (KR)

(21) Appl. No.: 19/362,518

(22) Filed: Oct. 20, 2025

(30) Foreign Application Priority Data
Oct. 23, 2024 (KR) 10-2024-0145607

(51) Int. Cl. G06T 7/80; G06T 5/80; G06T 7/13

(52) U.S. Cl. CPC G06T 7/80; G06T 5/80; G06T 7/13; G06T 2207/10024; G06T 2207/30221

(57) ABSTRACT

An alignment method of an electronic device includes receiving an original image including a structure for alignment, detecting lines of the structure based on the original image and performing preprocessing on the image by mapping the lines of the structure, generating three-dimensional (3D) coordinates of the structure based on one or more two-dimensional (2D) coordinates identified in the preprocessed image, and performing calibration based on the 3D coordinates.

### CROSS-REFERENCE TO RELATED APPLICATION

This application claims priority to and the benefit of Korean Patent Application No. 2024-0145607, filed on Oct. 23, 2024, the disclosure of which is incorporated herein by reference in its entirety.

### BACKGROUND

### 1. Field of the Invention

The technical idea of the present disclosure relates to an alignment method for sports including golf and an electronic device for performing the same.

### 2. Discussion of Related Art

In sports where a projectile is used, an alignment method is required, and an electronic device performs an alignment operation of identifying a projected direction as a correct direction in which the projectile is flying, by performing calibration on the movement of a projectile obtained through various sensors.

Among the sports, golf is a sport that requires precise technique to achieve the best result through an accurate clubhead direction and impact. To aid this, golfers primarily use visual indicators to adjust their swing and clubhead direction. Launch monitors have been developed for this purpose. A launch monitor is a device that tracks a clubhead's path and ball flying path in real time when hitting the ball and provide feedback to a player.

Since most existing alignment sticks, such as an alignment stick disclosed in Korean Patent Registration No. 10-2248980, were placed on the floor and used, so a launch monitor could not accurately recognize a direction indicated by the alignment stick, and there was a problem of tilting error due to recognizing a one-dimensional line. Furthermore, in the case of an outdoor launch monitor, it was inconvenient to carry an additional alignment stick.

### SUMMARY OF THE INVENTION

The present disclosure aims to smoothly perform alignment by precisely identifying the shape, line, and direction of an alignment structure through detection of changes in shape and brightness of a predetermined alignment structure.

According to an aspect of the present disclosure, there is provided an alignment method of an electronic device, which includes receiving an original image including a structure for alignment, detecting lines of the structure based on the original image and performing preprocessing on the image by mapping the lines of the structure, generating three-dimensional (3D) coordinates of the structure based on one or more two-dimensional (2D) coordinates identified in the preprocessed image, and performing calibration based on the 3D coordinates.

Further, the original image may include a first original image obtained by a first camera and a second original image obtained by a second camera, and the performing of the preprocessing may further include performing rectification on the first original image and the second original image.

Meanwhile, in the performing of the preprocessing, when the image is scanned in a predetermined direction and it is identified that a change in pixel value is greater than or equal to a predetermined value, edge points may be generated, and the lines of the structure may be detected based on the edge points.

Further, the direction in which the image is scanned may include a direction from a high value toward a low value on a Y-axis, and the change in the pixel value may include a change in pixel value from a low value to a high value.

Meanwhile, in the performing of the preprocessing, a first edge point and a second edge point may be generated according to predetermined edge point generation conditions, a plurality of intermediate edge points, which are generated sequentially and include a third edge point, may be generated, and the lines of the structure may be detected based on the first edge point, the second edge point, and the plurality of intermediate edge points.

Further, under the predetermined edge point generation conditions, when the image is scanned in the predetermined direction and it is identified that changes in pixel values are greater than or equal to a plurality of predetermined values, points at which it is identified that a change in pixel value is greater than or equal to an initial predetermined value may be generated as the edge points.

Meanwhile, in the performing of the preprocessing, when the image is scanned in a predetermined direction and it is identified that a chroma value is within a predetermined range, edge points may be generated, and the lines of the structure may be detected based on the edge points.

Meanwhile, in the generating of the 3D coordinates of the structure, a first edge point and a second edge point of a first image based on a first camera may be identified, a third edge point and a fourth edge point, which have substantially identical X-axis or Y-axis coordinates of the first edge point and the second edge point and correspond to the first edge point and the second edge point, respectively, from a second image based on a second camera may be generated, and the 3D coordinates may be generated based on the first edge point, the second edge point, the third edge point, and the fourth edge point.

Further, in the performing of the calibration based on the 3D coordinates, a golfer's hitting direction may be calibrated based on a direction of the detected line on the world coordinate system and a direction of a field of view (FoV) of a camera.

According to another aspect of the present disclosure, there is provided an electronic device for performing an alignment method, which includes a camera, and a processor configured to receive an original image including a structure for alignment from the camera, detect lines of the structure based on the original image, map the lines of the structure to perform preprocessing on the image, generate 3D coordinates of the structure based on one or more 2D coordinates identified in the preprocessed image, and perform calibration based on the 3D coordinates.

Further, the original image may include a first original image obtained by a first camera and a second original image obtained by a second camera, and the preprocessing may include performing rectification on the first original image and the second original image.

Meanwhile, in the preprocessing, when the image is scanned in a predetermined direction and it is identified that a change in pixel value is greater than or equal to a predetermined value, edge points may be generated, and the lines of the structure may be detected based on the edge points.

Further, the direction in which the image is scanned may include a direction from a high value toward a low value on a Y-axis, and the change in the pixel value may include a change in pixel value from a low value to a high value.

Meanwhile, in the preprocessing, a first edge point and a second edge point may be generated according to predetermined edge point generation conditions, a plurality of intermediate edge points, which are generated sequentially and include a third edge point, may be generated, and the lines of the structure may be detected based on the first edge point, the second edge point, and the plurality of intermediate edge points.

Further, under the predetermined edge point generation conditions, when the image is scanned in the predetermined direction and it is identified that changes in pixel values are greater than or equal to a plurality of predetermined values, points at which it is identified that a change in pixel value is greater than or equal to an initial predetermined value may be generated as the edge points.

Meanwhile, in the preprocessing, when the image is scanned in a predetermined direction and it is identified that a chroma value is within a predetermined range, edge points may be generated, and the lines of the structure may be detected based on the edge points.

Meanwhile, the processor may identify a first edge point and a second edge point of a first image based on a first camera, generate a third edge point and a fourth edge point, which have substantially identical X-axis or Y-axis coordinates of the first edge point and the second edge point and correspond to the first edge point and the second edge point, respectively, from a second image based on a second camera, and generate the 3D coordinates based on the first edge point, the second edge point, the third edge point, and the fourth edge point.

Further, the processor may calibrate a golfer's hitting direction based on a direction of the detected line on the world coordinate system and a direction of a FoV of a camera, and perform calibration based on the 3D coordinates.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram for describing an electronic device according to an exemplary embodiment of the present disclosure;

FIG. 2 is a flowchart for describing alignment according to an exemplary embodiment of the present disclosure;

FIG. 3 is a flowchart for describing a coordinate preprocessing operation according to an exemplary embodiment of the present disclosure;

FIG. 4 is a flowchart for describing a coordinate generation operation according to an exemplary embodiment of the present disclosure;

FIG. 5 is a diagram for describing a rectification operation according to an exemplary embodiment of the present disclosure;

FIG. 6 is a diagram for describing edge point detection according to an exemplary embodiment of the present disclosure;

FIGS. 7 to 9 are diagrams for describing line detection according to an exemplary embodiment of the present disclosure;

FIG. 10 is a diagram for describing line mapping and two-dimensional (2D) coordinate generation according to an exemplary embodiment of the present disclosure.

### DETAILED DESCRIPTION OF EXEMPLARY EMBODIMENTS

Specific structural or functional descriptions of embodiments are disclosed for illustrative purposes only and may be modified and implemented in various forms. Therefore, the form actually implemented is not limited to the specific embodiments disclosed, and the scope of the present specification includes modifications, equivalents, or alternatives included in the technical idea described in the embodiments.

It should be understood that, although the terms “first,” “second,” and the like may be used herein to describe various elements, the terms are only used to distinguish one element from another element. For example, a first element could be termed a second element, and similarly, a second element could be termed a first element.

As used herein, the singular forms “a” and “an” are intended to also include the plural forms, unless the context clearly indicates otherwise. In this specification, expressions such as “A or B,” “at least one of A and B,” “at least one of A or B,” “A, B, or C,” “at least one of A, B, and C,” and “at least one of A, B, or C” may include any one of the items listed together in that phrase, or all possible combinations thereof. It should be further understood that the terms “comprise,” “comprising,” “include,” and/or “including,” when used herein, specify the presence of stated features, integers, steps, operations, elements, parts, or combinations thereof, but do not preclude the presence or addition of one or more other features, integers, steps, operations, elements, parts, or combinations thereof.

Hereinafter, embodiments of the present disclosure will be described in detail with reference to the accompanying drawings. In the description with reference to the accompanying drawings, the same components are denoted by the same reference numerals, and the description thereof will not be repeated.

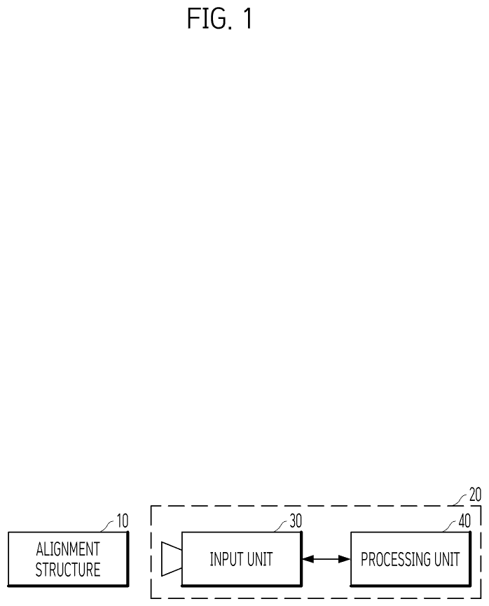

FIG. 1 is a block diagram for describing an electronic device according to an exemplary embodiment of the present disclosure.

An electronic system may include an alignment structure 10 and an electronic device 20. The electronic device 20 may include an input unit 30 and a processing unit 40, and the electronic device 20 may sense an exterior of the alignment structure 10. For example, the input unit 30 may be implemented as a camera to photograph the alignment structure 10, and the processing unit 40 may identify the exterior of the alignment structure 10 including a sensing line and calculate a direction indicated by the alignment structure 10.

The alignment structure 10 and the electronic device 20 may constitute the electronic system in that the electronic device 20 may identify the alignment structure 10 and calculate a correct hitting direction. Specifically, the electronic system may perform an alignment operation based on a result of identifying the sensing line included in a head stick.

The electronic device 20 may be, for example, a launch monitor, and may be used in a golf sport. The present disclosure is not limited thereto, and the electronic device 20 may be implemented as any of various electronic devices such as a personal computer (PC), a tablet computer, a portable media player (PMP), a personal digital assistant (PDA), and a smartphone.

The input unit 30 may be implemented using any of various sensor devices capable of identifying objects, such as an image sensor, a lidar sensor, a radar sensor, an ultrasonic sensor, etc.

The processing unit 40 may be a component for controlling the electronic device 20 overall. For example, the processing unit 40 may be implemented as a digital signal processor (DSP) for processing digital signals, a microprocessor, or a time controller (TCON). However, the present disclosure is not limited thereto, and the processing unit 40 may include one or more of a central processing unit (CPU), a micro controller unit (MCU), a micro processing unit (MPU), a controller, an application processor (AP), a communication processor (CP), and an advanced reduced instruction set computer (RISC) machine (ARM) processor, or may be defined by the terms thereof. Further, the processing unit 40 may be implemented as a system on chip (SoC) or large scale integration (LSI) with a built-in processing algorithm or may be implemented in the form of a field-programmable gate array (FPGA).

Meanwhile, although not illustrated, the electronic device 20 may further include a communication unit including a communication module for communication with an external electronic device, a memory device capable of transitory or non-transitory storing data, a display device capable of outputting data in the form of an image, and a speaker device capable of outputting data in the form of audio.

In this case, a method performed by the electronic device may be stored in the form of a memory device, which is a non-transitory computer-readable recording medium, and may be read out and performed by the processing unit 40.

The processing unit 40 may accurately detect a target direction indicated by the alignment structure 10 on the world coordinate system, which may be a starting point for accurately calculating the physical quantity of a ball hit by a golfer.

To this end, the present disclosure is directed to providing a method in which the processing unit 40 performs accurate alignment by performing preprocessing, generating coordinates, and calibrating operations according to the present disclosure based on the data received from the input unit 30.

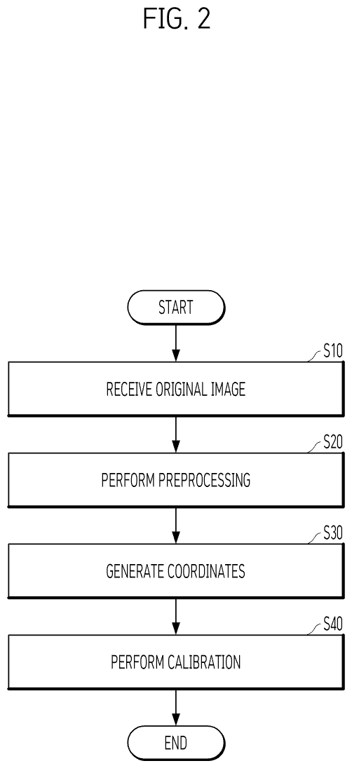

FIG. 2 is a flowchart for describing alignment according to an exemplary embodiment of the present disclosure.

Referring to FIG. 2, an electronic device 20 may receive an original image from an input unit 30 (S10), perform a preprocessing operation (S20), then generate coordinates based on preprocessed data (S30), and perform a calibration operation based on the generated coordinates (S40).

Specifically, a processing unit 40 may receive an original image including an alignment structure 10. A golf course or an indoor practice range may be the background, and the alignment structure 10 may be included as a main subject.

The processing unit 40 may perform the preprocessing operation (S20).

The processing unit 40 may detect lines of the alignment structure 10 based on the original image received from the input unit 30. Here, “lines of the alignment structure 10” may mean edges of a specific portion of the alignment structure 10. For example, the alignment structure 10 viewed by the input unit 30 may be observed as a two-dimensional (2D) image. The “lines of the alignment structure 10” may mean edges of a specific portion of the 2D alignment structure 10 in a 2D image.

Here, the input unit 30 may include at least one camera, and the input unit 30 may include, for example, a first camera and a second camera. The first camera and the second camera may be included in the electronic device 20 and installed at physically different positions to be spaced apart from each other.

For example, when the first camera and the second camera are vertically arranged in the same position laterally, in a first original image output from the first camera and a second original image output from the second camera, left and right end positions of the alignment structure 10 may be substantially identical to each other, and upper and lower end positions of the alignment structure 10 may be different from each other.

On the other hand, when the first camera and the second camera are laterally arranged in the same position vertically, in the first original image output from the first camera and the second original image output from the second camera, the upper and lower end positions of the alignment structure 10 may be substantially identical to each other, and the left and right end positions of the alignment structure 10 may be different from each other.

Therefore, by performing a rectification operation in order to correct the positions of the alignment structure 10 captured in the first original image and the second original image, a first pair image and a second pair image may be generated from the first original image and the second original image, respectively.

The processing unit 40 may detect the lines of the alignment structure 10 using pixel values. In order to detect a target direction of the alignment structure 10, an edge line of a specific structure of the alignment structure 10 should first be identified, and in order to identify the edge line, edge points may each be identified.

The processing unit 40 may generate coordinate values (S30).

When the processing unit 40 identifies all the edge points, the processing unit 40 may generate the edge line based on the edge points, and on the other hand, the processing unit 40 may obtain 2D coordinates of all or some of the edge points.

The processing unit 40 may identify three-dimensional (3D) coordinates based on the obtained 2D coordinates. For example, when identical scenes are obtained from two cameras, specific points are obtained identically in each scene, and information on positions at which the two cameras are arranged is known, the processing unit 40 may identify the 3D coordinates of the alignment structure 10 by performing a triangulation operation.

The processing unit 40 may perform the calibration operation (S40).

The processing unit 40 may detect the target direction of the alignment structure 10 in the world coordinate system based on the 3D coordinates, perform a calibration operation of setting the target direction as a correct direction, instead of setting a direction perpendicular to a direction of a field of view (FoV) of the input unit 30 as the correct direction, and accordingly, perform an alignment operation of a launch monitor.

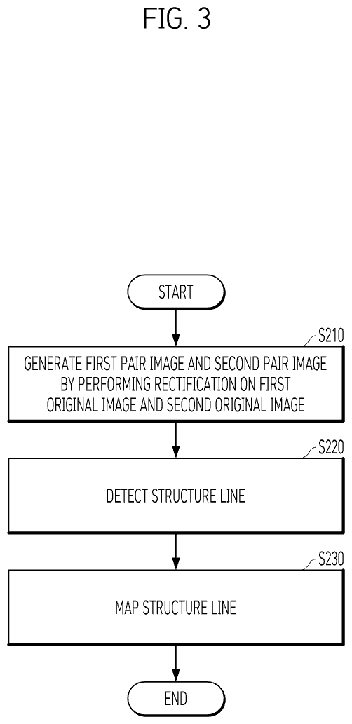

FIG. 3 is a flowchart for describing a coordinate preprocessing operation according to an exemplary embodiment of the present disclosure.

An input unit 30 may include two cameras including a first camera and a second camera. However, the technical idea of the present disclosure is not limited to the number or the type of device called a camera.

A processing unit 40 may receive a first original image obtained by the first camera and a second original image obtained by the second camera. Here, “original image” does not mean an image in a specific raw data file format but may mean all data that is captured by the camera and transmitted to the processing unit 40.

The first original image and the second original image may be images which are captured at substantially the same time point. For example, the first camera and the second camera may receive synchronized capture signals.

As described above in FIG. 2, since the positions (i.e., coordinates of pixels) of the alignment structure 10 that are captured in the first original image and the second original image may be different from each other, the processing unit 40 may perform a rectification operation and generate a first pair image based on the first original image and a second pair image based on the second original image (S210).

The processing unit 40 may detect lines of the alignment structure 10 (S220).

As an example, the processing unit 40 may scan an image in a predetermined direction, generate edge points when it is identified that a change in pixel value is greater than or equal to a predetermined value, and detect the lines of the alignment structure 10 based on the edge points.

Here, the pixel value may include the degree of brightness or darkness of a pixel, and include luminance, brightness, and/or brightness value. For example, when a first pixel is relatively dark and a second pixel, which is a continuous neighboring pixel during scanning, becomes relatively bright, the processing unit 40 may identify the second pixel as an edge point. Alternatively, the processing unit 40 may identify the first pixel as an edge point.

In other words, the processing unit 40 may scan the image in a direction from a high value to a low value on a Y-axis to identify an upper edge of the alignment structure 10, and when it is identified that the pixel value that remains low and then increases to a pixel value is higher than or equal to the predetermined value, the processing unit 40 may generate a specific pixel as an edge point.

As another example, when the processing unit 40 scans the image in a predetermined direction to identify a chroma value within a predetermined range, the processing unit 40 may generate edge points. For example, the processing unit 40 may store information indicating that the alignment structure 10 is blue and generate edge points when a specific pixel is identified as having a chroma value within a range that includes blue.

The processing unit 40 may detect structure lines by connecting the identified edge points (S220).

Thereafter, the processing unit 40 may map a first structure line and a second structure line to each other (S230).

Specifically, the processing unit 40 may detect the second structure line in the second pair image based on the first structure line detected in the first pair image. Further, the processing unit 40 may identify that edge points at both ends of the first structure line correspond to edge points at both ends of the second structure line. In other words, the line mapping may mean identifying substantially identical points in the real world in the first and second pair images.

In contrast, the processing unit 40 may detect the first structure line and the second structure line in the first pair image and the second pair image, respectively, using the method of operation S220.

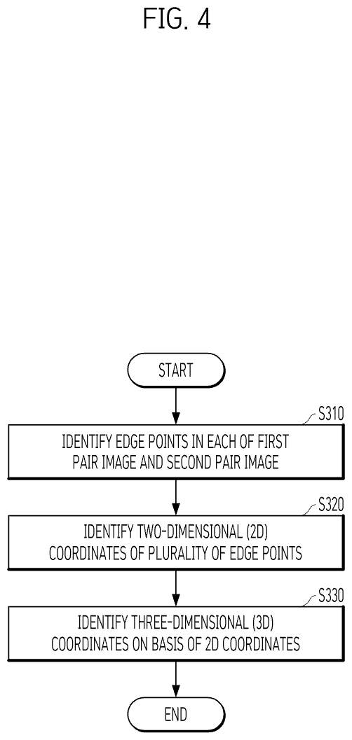

FIG. 4 is a flowchart for describing a coordinate generation operation according to an exemplary embodiment of the present disclosure.

A processing unit 40 may identify edge points in each of a first pair image and a second pair image (S310).s

The processing unit 40 may identify a first edge point and a second edge point, which are points at opposite ends in the first pair image, and identify a third edge point and a fourth edge point, which are points at opposite ends in the second pair image.

The processing unit 40 may identify a plurality of 2D coordinates (S320).

For example, the processing unit 40 may identify 2D coordinates of each of the first edge point and the third edge point and identify the 2D coordinates as pixel positions within a 2D image.

The processing unit 40 may identify X-axis coordinate values or Y-axis coordinate values of the first edge point and the third edge point as being substantially identical to each other, and identify the remaining coordinate values as being different from each other. The second edge point and the fourth edge point may also be identified in a similar manner.

The processing unit 40 may identify 3D coordinates based on the 2D coordinates (S330).

For example, the 3D coordinates of the alignment structure 10 may be identified using a difference in Y-axis pixel values occurring at the first edge point and the third edge point and information on an actual length at which two cameras are arranged to be spaced apart from each other at different heights.

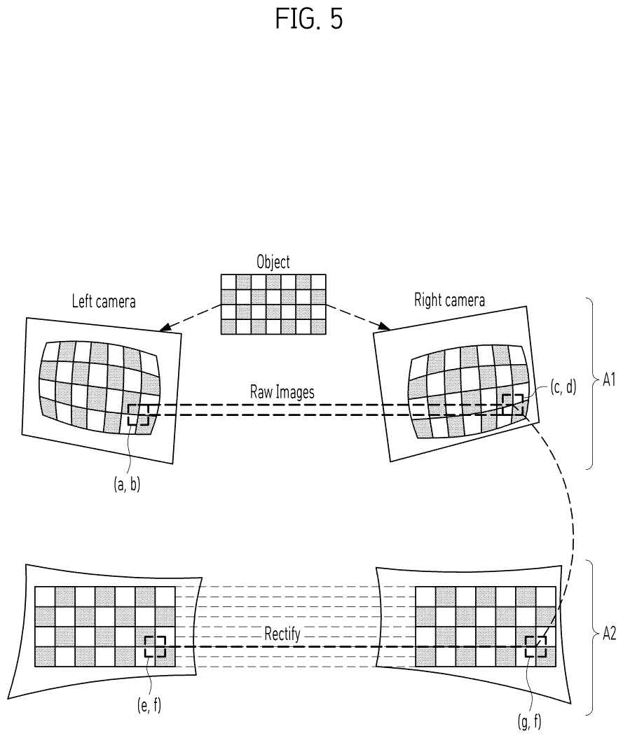

FIG. 5 is a diagram for describing a rectification operation according to an exemplary embodiment of the present disclosure.

Referring to FIG. 5, a first camera may be a left camera, a second camera may be a right camera, and a specific point of an object in the real world will be described.

The first camera and the second camera may capture original images A1, and the original image A1 may include both a left-eye image and a right-eye image.

A specific point in the left-eye image from the first camera and a specific point in the right-eye image from the second camera may have pixel coordinates (a, b) and (c, d), respectively.

A processing unit 40 may perform a rectification operation on each of the left-eye image and the right-eye image, and accordingly, the Y-axis coordinates may be substantially identical to each other with a value “f.” Therefore, a specific point in a left-eye pair image and a specific point in a right-eye pair image may have pixel coordinates (e, f) and (g, f), respectively. Here, the Y-axis coordinates in the two coordinates (e, f) and (g, f) described above may be identical, and at least some of a, c, b, d, f, and g may be identical.

Meanwhile, the first camera and the second camera may be a top camera and a bottom camera, respectively. That is, the first camera and the second camera may be arranged at different positions within the same width. Hereinafter, the first camera and the second camera will be described as being the top camera and the bottom camera, respectively. In this case, the X-axis coordinates of the specific points in the first pair image and the second pair image may be substantially identical to each other.

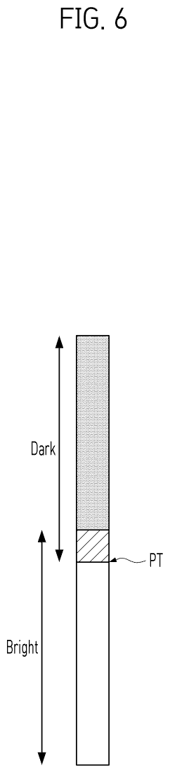

FIG. 6 is a diagram for describing edge point detection according to an exemplary embodiment of the present disclosure.

Referring to FIG. 6, when a processing unit 40 scans an image from top to bottom, the processing unit 40 may identify a point PT with a high pixel value as an edge point.

For example, when the processing unit 40 identifies a pixel value of an uppermost pixel of the image and identifies that the pixel value is lower than a predetermined pixel value, the processing unit 40 may identify pixel values of adjacent pixels. When the identified pixel values are also lower than the predetermined pixel value, the processing unit 40 may re-identify the pixel values of the adjacent pixels. While repeating this operation, when the processing unit 40 identifies that a pixel value of a specific pixel is equal to or higher than the predetermined pixel value, the processing unit 40 may generate the identified pixel or the previous pixel as an edge point.

The processing unit 40 may detect the edge point based on the Haar-like-Feature response method, and as another example, the processing unit 40 may detect the edge point based on at least one of the Sobel filter, Harris corner detection, Hough line, and labeling methods.

Hereinafter, the operation of identifying or generating the specific pixel as the edge point through that in FIG. 6 may be referred to as an edge point generation condition.

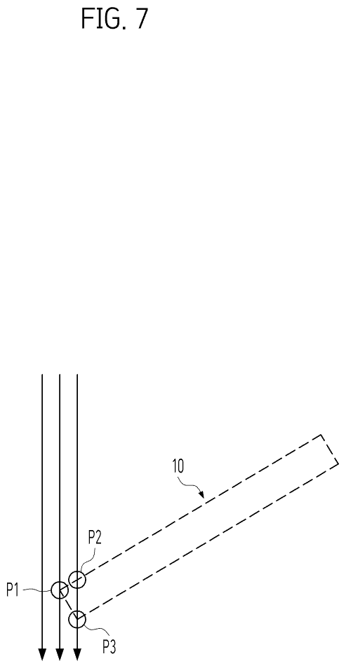

FIGS. 7 to 9 are diagrams for describing line detection according to an exemplary embodiment of the present disclosure.

Referring to FIG. 7, a processing unit 40 may perform a scan operation on a first column but may not find any pixels that meet predetermined edge point generation conditions. Thereafter, the processing unit 40 may scan a second column adjacent thereto.

The processing unit 40 may identify that a specific pixel P1 meets the predetermined edge point generation conditions by scanning the second column and generate the specific pixel P1 as an edge point. After scanning down to a last pixel of the second column is completed, the processing unit 40 may scan a third column adjacent thereto.

The processing unit 40 may identify that a pixel value of a pixel P2 is significantly increased and a pixel value of a pixel P3 is significantly decreased by scanning the third column. Among them, the pixel P2 meets the predetermined edge point generation condition and the pixel P3 does not, and thus the processing unit 40 may generate the pixel P2 as an edge point.

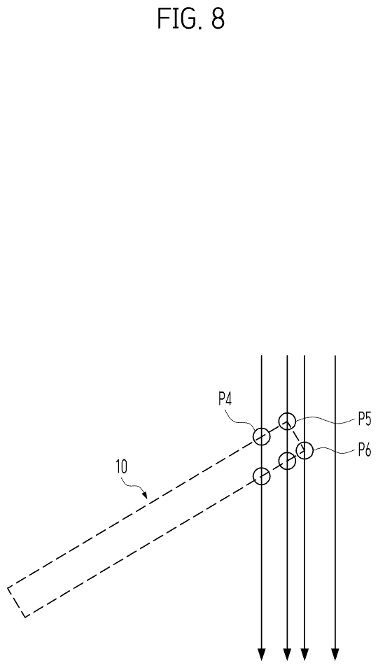

Referring to FIG. 8, the processing unit 40 may identify that pixels P4 and P5 meet the predetermined edge point generation conditions, similar to that described in FIG. 7, and generate the pixels P4 and P5 as edge points.

Further, the processing unit 40 may identify the edge points according to the pixels P1, P2, P4, and P5 and calculate slope values relative to the previous edge point. That is, the processing unit 40 may identify the pixel P5, calculate the slope value relative to the pixel P4, and when the calculated slope value satisfies a predetermined slope condition, the processing unit 40 may generate the pixel P5 as an edge point. Accordingly, the processing unit 40 may not generate the pixel P6 as an edge point because the pixel P6 meets the predetermined edge point generation conditions but does not satisfy the predetermined slope condition. For example, in the case in which the alignment structure 10 has a rod shape, when the slope values of the pixel P5 and the pixel P6 are calculated as negative numbers rather than positive numbers, the pixel P6 may not be generated as an edge point.

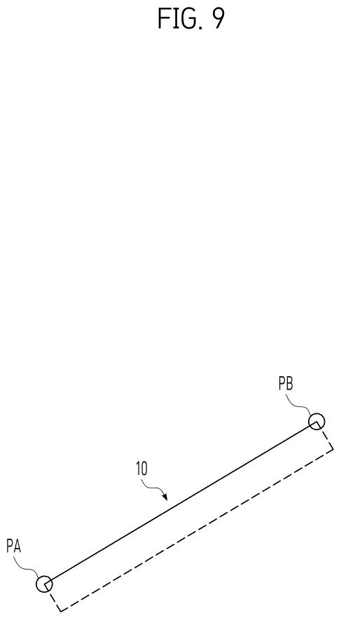

Referring to FIG. 9, the processing unit 40 may generate an edge line by connecting edge points PA and PB corresponding to the identified pixels P1, P2, P4, and P5. In generating the edge line, the processing unit 40 may also interpolate the edge points.

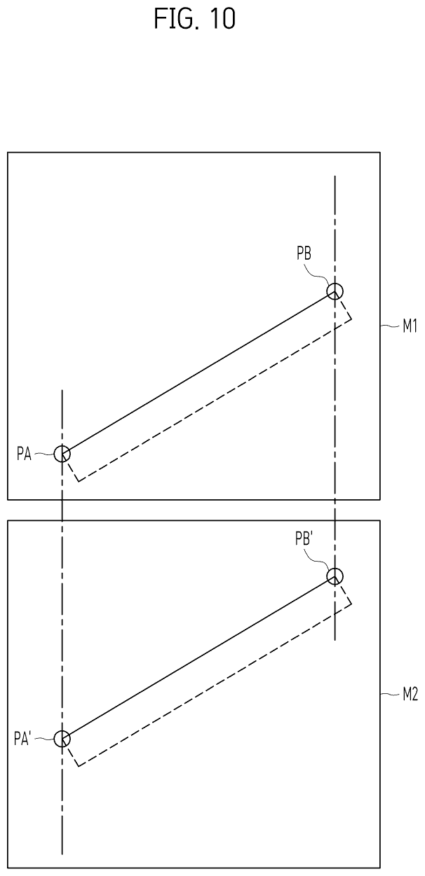

FIG. 10 is a diagram for describing line mapping and 2D coordinate generation according to an exemplary embodiment of the present disclosure.

A processing unit 40 may identify a first edge point PA and a second edge point PB in a first pair image M1 and identify a third edge point PA′ and a fourth edge point PB′ in a second pair image M2 through line mapping. Through the line mapping, X-axis coordinates of the first edge point PA and the third edge point PA′ are substantially identical to each other within the image, and X-axis coordinates of the second edge point PB and the fourth edge point PB′ are substantially identical to each other within the image.

In the present disclosure, the meaning of “substantially identical to each other” is to mean substantially identical to each other to the extent that there is a very small difference in pixel positions within an innumerable number of pixels in an image and is not limited to meaning that the pixel positions are physically identical to each other.

Meanwhile, the processing unit 40 may store information on actual positions of a first camera, which is the basis of a first pair image M1, and a second camera, which is the basis of a second pair image M2, on the world coordinate system, and may derive 3D coordinates and 3D positions of an alignment structure 10 on the world coordinate system using all information on the positions of the edge points PA, PB, PA′, and PB′.

A processing unit 40 may store reference information on a normal vector direction with respect to a FoV(Field of View) direction of a camera as world coordinate system information. The processing unit 40 may calculate an accurate direction of a ball struck by a golfer by using a difference of a target direction derived according to the technical idea of the present disclosure from the reference information.

In the alignment method according to the technical idea of the present disclosure, by accurately identifying a target direction indicated by an alignment structure, through detecting a line of the alignment structure, mapping the line, and detecting 2D and 3D coordinates of the alignment structure, the data accuracy of a launch monitor can be improved for a golfer.

As described above, while the embodiments have been described with reference to specific embodiments and drawings, various modifications and alterations may be made by those skilled in the art from the above description. For example, when the described technologies are performed in orders different from the described methods, and/or the described components such as a system, a structure, a device and a circuit are coupled or combined in the form different from the described method, or replaced or substituted with other components or equivalents, the appropriate result may be achieved.

Therefore, other implementations, other embodiments, and equivalents within the scope of the appended claims are included in the range of the claims to be described.

What is claimed is:

1. An alignment method of an electronic device, the alignment method comprising:
receiving an original image including a structure for alignment;
detecting lines of the structure based on the original image and performing preprocessing on the original image by mapping the detected lines of the structure;
generating three-dimensional (3D) coordinates of the structure based on one or more two-dimensional (2D) coordinates identified in the preprocessed image; and
performing a calibration operation to set the target direction to a correct direction based on the 3D coordinates.

2. The alignment method of claim 1, wherein the original image includes a first original image obtained by a first camera and a second original image obtained by a second camera, and
the performing of the preprocessing further includes performing rectification on the first original image and the second original image.

3. The alignment method of claim 1, wherein, in the performing of the preprocessing, when the image is scanned in a predetermined direction and it is identified that a change in pixel value is greater than or equal to a predetermined value, edge points are generated, and the lines of the structure are detected based on the edge points.

4. The alignment method of claim 3, wherein the direction in which the image is scanned includes a direction from a high value toward a low value on a Y-axis, and the change in the pixel value includes a change in pixel value from a low value to a high value.

5. The alignment method of claim 3, wherein, in the performing of the preprocessing, a first edge point and a second edge point are generated according to predetermined edge point generation conditions, a plurality of intermediate edge points, which are generated sequentially and include a third edge point, are generated, and the lines of the structure are detected based on the first edge point, the second edge point, and the plurality of intermediate edge points.

6. The alignment method of claim 5, wherein the predetermined edge point generation conditions comprise generating, if a plurality of points are identified as having a pixel value change equal to or greater than a predetermined value while scanning the image in a predetermined direction, an edge point as a first identified point among the plurality of points.

7. The alignment method of claim 1, wherein, in the performing of the preprocessing, when the original image is scanned in a predetermined direction and it is identified that a chroma value is within a predetermined range, edge points are generated, and the lines of the structure are detected based on the edge points.

8. The alignment method of claim 1, wherein, in the generating of the 3D coordinates of the structure,
a first edge point and a second edge point of a first original image based on a first camera are identified,
a third edge point and a fourth edge point, which have substantially identical X-axis or Y-axis coordinates of the first edge point and the second edge point and correspond to the first edge point and the second edge point, respectively, from a second original image based on a second camera are generated, and
the 3D coordinates are generated based on the first edge point, the second edge point, the third edge point, and the fourth edge point.

9. The alignment method of claim 8, wherein, in the performing of the calibration based on the 3D coordinates, a golfer's hitting direction is calibrated based on a direction of the detected lines on a world coordinate system and a direction of a field of view (FoV) of a camera.

10. An electronic device for performing an alignment method, the electronic device comprising:
a camera; and
a processor configured to receive an original image including a structure for alignment from the camera, detect lines of the structure based on the original image, map the lines of the structure to perform preprocessing on the image, generate three-dimensional (3D) coordinates of the structure based on one or more two-dimensional (2D) coordinates identified in the preprocessed image, and perform calibration based on the 3D coordinates.

11. The electronic device of claim 10, wherein the camera comprises a first camera and a second camera,
the original image includes a first original image obtained by the first camera and a second original image obtained by the second camera, and
the preprocessing includes performing rectification on the first original image and the second original image.

12. The electronic device of claim 10, wherein, in the preprocessing, when the image is scanned in a predetermined direction and it is identified that a change in pixel value is greater than or equal to a predetermined value, edge points are generated, and the lines of the structure are detected based on the edge points.

13. The electronic device of claim 12, wherein the direction in which the image is scanned includes a direction from a high value toward a low value on a Y-axis, and the change in the pixel value includes a change in pixel value from a low value to a high value.

14. The electronic device of claim 12, wherein, in the preprocessing, a first edge point and a second edge point are generated according to predetermined edge point generation conditions, a plurality of intermediate edge points, which are generated sequentially and include a third edge point, are generated, and the lines of the structure are detected based on the first edge point, the second edge point, and the plurality of intermediate edge points.

15. The electronic device of claim 14, wherein the predetermined edge point generation conditions comprise generating, if a plurality of points are identified as having a pixel value change equal to or greater than a predetermined value while scanning the image in a predetermined direction, an edge point as a first identified point among the plurality of points.

16. The electronic device of claim 10, wherein, in the preprocessing, when the image is scanned in a predetermined direction and it is identified that a chroma value is within a predetermined range, edge points are generated, and the lines of the structure are detected based on the edge points.

17. The electronic device of claim 10, wherein the processor is configured to:
identify a first edge point and a second edge point of a first original image based on a first camera;
generate a third edge point and a fourth edge point, which have substantially identical X-axis or Y-axis coordinates of the first edge point and the second edge point and correspond to the first edge point and the second edge point, respectively, from a second original image based on a second camera; and
generate the 3D coordinates based on the first edge point, the second edge point, the third edge point, and the fourth edge point.

18. The electronic device of claim 17, wherein the processor calibrates a golfer's hitting direction based on a direction of the detected lines on a world coordinate system and a direction of a field of view (FoV) of a camera, and performs calibration based on the 3D coordinates.
